(19) United States
(12) Patent Application Publication
(10) Pub. No.: US 2025/0101946 A1
(43) Pub. Date: Mar. 27, 2025

(54) Systems, Methods and Tools for Active Wake Control of Wind Turbines

(71) Applicant: National Technology & Engineering Solutions of Sandia, LLC, Albuquerque, NM (US)

(72) Inventors: Lawrence Cheung, Livermore, CA (US); Kenneth A. Brown, Albuquerque, NM (US); Daniel R. Houck, Albuquerque, NM (US); Nathaniel deVelder, Albuquerque, NM (US); Carsten H. Westergaard, Houston, TX (US); Gopal Robert Yalla, Westfield, NJ (US)

(21) Appl. No.: 18/898,090

(22) Filed: Sep. 26, 2024

Related U.S. Application Data
(60) Provisional application No. 63/540,490, filed on Sep. 26, 2023.

(51) Int. Cl. F03D 7/04; F03D 7/02

(52) U.S. Cl. CPC F03D 7/049; F03D 7/0224; F05B 2260/70; F05B 2270/204; F05B 2270/327

(57) ABSTRACT

A reduction in wake effects in large wind farms through wake-aware control can improve farm efficiency. The wake of a wind turbine presents complications for nearby turbines, depending on the atmospheric conditions, turbine characteristics, and turbine siting. The nascent field of wind farm flow control seeks to reduce the deleterious effects of the wake momentum deficit by leveraging the turbine as a flow actuator though the intelligent scheduling of either the blade pitch, rotor speed, or nacelle yaw.

### RELATED APPLICATION

This application claims priority to U.S. Provisional Patent Application No. 63/540,490, filed on Sep. 26, 2023, entitled “Systems, Methods and Tools for Active Wake Control of Wind Turbines” by Cheung et al., the entirety of which is incorporated herein by reference in its entirety.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD

The present disclosure is generally directed to wind turbine control and more particularly directed to active wake control of wind turbines.

### BACKGROUND

Current wind farm operations and power production capacity are restricted by wake effects of upstream wind turbines. This may be exasperated by wind farms with a high density of turbines per square kilometer, though wake effects are an inherent phenomenon in any wind farm. Current control methods to address wake effects include static induction control, semi-static, wake steering control (the actuator is extremely slow compared to the flow time scales involved), and active wake control directly addressing relevant time scales of the flow properties.

It is well known that the behavior of wind turbine wakes is heavily influenced by the shear in the incoming wind profile and the thermal stratification of the surrounding atmospheric boundary layer. While the stability of axisymmetric wakes has been well established in the literature, a direct stability analysis of wakes in the presence of these effects is less well known. The wind shear and stratification appear as non-axisymmetric variations in the mean flow but have not been accounted for in prior analyses of active wake control.

What is needed are systems, methods, and tools that can control wind turbine operations in a wind turbine farm that overcome these limitations of the prior art.

### SUMMARY OF THE DISCLOSURE

The present disclosure is directed to an active wake control method that includes periodically changing blade pitch of one or more blades of a first wind turbine to accelerate wake recovery.

The present disclosure is further directed to a controller that includes a module that includes a processor comprising non-transitory storage medium for providing instructions to a turbine blade pitch actuator, the instructions including periodically changing blade pitch of one or more blades of a first wind turbine to accelerate wake recovery.

An advantage of the present disclosure is to ensure optimal, real-time selection of forcing frequency and amplitude used in wake mixing control to maximize wake recovery downstream of a wind turbine and minimize loading on the active turbine itself. These two effects together increase the profitability of the wind farm while not reducing its lifetime.

Another advantage of the present disclosure is to allow for increased power density in new and existing wind farms. Existing wind farms using AWC will increase the power output of downstream turbines in their existing footprint while new farms designed to use AWC can consider smaller inter-turbine spacings without loss of power to reduce the overall wind farm footprint.

Another advantage of the present disclosure is to allow for closed-loop control through inexpensive flow sensing methods, which may already be present at established wind farms. Understanding that inflow is an abstract term that simple means determining the inflow properties by methods relevant to the design of the AWC system.

Another advantage of the present disclosure is that it can be used in conjunction with wake steering and/or static induction control methods.

Another advantage of the present disclosure is that it can be used in conjunction with individual pitch and/or rotor speed control for load reduction.

Another advantage of the present disclosure is that all other typical turbine controls may continue to be used as normally without affecting their performance when also using AWC.

### BRIEF DESCRIPTION OF THE DRAWINGS

FIG. 1A shows a helical coherent structure excited by a wind turbine applying the helix method according to an embodiment of the disclosure.

FIG. 1B shows a solid disk undergoing a nutation motion.

FIG. 2 shows a time trace of normalized blade pitch signal, θ_{b}(t), for several different variations in forcing of azimuthal modes. The expressions above the plot indicate periods of interest for each forcing strategy in terms of the angular excitation frequency, We, and the angular shaft frequency, Ω.

FIG. 3 is a schematic of the cylindrical coordinate system relative to the turbine.

FIG. 4A shows the baseline relative variation in blade loading due to applied pitching strategy, wherein the curve corresponds to the fluctuating axial blade loading profile, \hat{F}ⱼₖ, at St=0.30 at a particular azimuthal mode number, n, normalized by the mean axial blade loading, g, F̅.

FIG. 4B shows the relative variation in blade loading due to applied pitching strategy, wherein the curve corresponds to the fluctuating axial blade loading profile, \hat{F}ⱼₖ, at St=0.30 at a particular azimuthal mode number, n, normalized by the mean axial blade loading, g, F̅.

FIG. 4C shows the relative variation in blade loading due to applied pitching strategy, wherein the curve corresponds to the fluctuating axial blade loading profile, \hat{F}ⱼₖ, at St=0.30 at a particular azimuthal mode number, n, normalized by the mean axial blade loading, F̅.

FIG. 4D shows the relative variation in blade loading due to applied pitching strategy, wherein the curve corresponds to the fluctuating axial blade loading profile, \hat{F}ⱼₖ, at St=0.30 at a particular azimuthal mode number, n, normalized by the mean axial blade loading, F̅.

FIG. 4E shows the relative variation in blade loading due to applied pitching strategy, wherein the curve corresponds to the fluctuating axial blade loading profile, \hat{F}ⱼₖ, at St=0.30 at a particular azimuthal mode number, n, normalized by the mean axial blade loading, F̅.

FIG. 4F shows the relative variation in blade loading due to applied pitching strategy, wherein the curve corresponds to the fluctuating axial blade loading profile, F̅ⱼₖ, at St=0.30 at a particular azimuthal mode number, n, normalized by the mean axial blade loading, F̅.

FIG. 5 shows contours of out-of-plane vorticity magnitude on the hub-height plane for the six cases listed in Table 1.

FIG. 6A shows a baseline streamwise development of modal energy gain at St=0.3 as represented by the normalized eigenvalue, λ¹. Normalization is performed on the constant Δ_{c}¹, which is the λ¹ for the n=0 mode of the N0 case in FIG. 6B.

FIG. 6B shows streamwise development of modal energy gain at St=0.3 as represented by the normalized eigenvalue, λ¹, for N0. Normalization is performed on the constant Δ_{c}¹, which is the λ¹ for the n=0 mode of the N0 case in FIG. 6B.

FIG. 6C shows streamwise development of modal energy gain at St=0.3 as represented by the normalized eigenvalue, λ¹, for N1P. Normalization is performed on the constant λ_{c}¹, which is the λ¹ for the n=0 mode of the N0 case in FIG. 6B.

FIG. 6D shows streamwise development of modal energy gain at St=0.3 as represented by the normalized eigenvalue, λ¹, for N1M. Normalization is performed on the constant λ_{c}¹, which is the λ¹ for the n=0 mode of the N0 case in FIG. 6B.

FIG. 6E shows streamwise development of modal energy gain at St=0.3 as represented by the normalized eigenvalue, λ¹, for N1PIM. Normalization is performed on the constant λ_{c}¹, which is the λ¹ for the n=0 mode of the N0 case in FIG. 6B.

FIG. 6F shows streamwise development of modal energy gain at St=0.3 as represented by the normalized eigenvalue, λ¹ for N1PIM CL90. Normalization is performed on the constant λ_{c}¹, which is the λ¹ for the n=0 mode of the N0 case in FIG. 6B.

FIG. 7A shows baseline contours of normalized radial shear stress flux—ūₓu̅′̅ₓ̅u̅′̅ᵣ̅, in the yz plane at 7D from the rotor for the simplified inflow case. Data have been normalized by the cubed hub-height inflow velocity u_{x,hub}.

FIG. 7B shows contours of normalized radial shear stress flux—ūₓu̅′̅ₓ̅u̅′̅ᵣ̅, in the yz plane at 7D from the rotor for the simplified inflow case for NO. Data have been normalized by the cubed hub-height inflow velocity u_{x,hub}.

FIG. 7C shows contours of normalized radial shear stress flux—ūₓu̅′̅ₓ̅u̅′̅ᵣ̅, in the yz plane at 7D from the rotor for the simplified inflow case for N1P. Data have been normalized by the cubed hub-height inflow velocity u_{x,hub}.

FIG. 7D shows contours of normalized radial shear stress flux, −ūₓu̅′̅ₓ̅u̅′̅ᵣ̅, in the yz plane at 7D from the rotor for the simplified inflow case for N1M. Data have been normalized by the cubed hub-height inflow velocity u_{x,hub}.

FIG. 7E shows contours of normalized radial shear stress flux, −ūₓu̅′̅ₓ̅u̅′̅ᵣ̅, in the yz plane at 7D from the rotor for the simplified inflow case for N1PIM CL00. Data have been normalized by the cubed hub-height inflow velocity u_{x,hub}.

FIG. 7F shows contours of normalized radial shear stress flux, −ūₓu̅′̅ₓ̅u̅′̅ᵣ̅, in the yz plane at 7D from the rotor for the simplified inflow case for N1PIM CL90. Data have been normalized by the cubed hub-height inflow velocity u_{x,hub}.

FIG. 8 shows a normalized radial shear stress flux, −ūₓu̅′̅ₓ̅u̅′̅ᵣ̅, averaged along the projected rotor-tip perimeter in the yz plane versus streamwise distance, x/D from the rotor. Normalization is performed on the third power of inflow velocity at hub height, u_{x,hub}.

FIG. 9 shows a streamwise development of normalized rotor-averaged axial velocity, [symbol] u̅ₓ̅ [symbol] rotor/u_{x,hub}. Normalization is performed on the third power of inflow velocity at hub height, u_{x,hub}.

FIG. 10A shows streamwise development of modal energy gain at various St as represented by λ¹/λ¹_{x/D=0.05} for the LES data. Normalization is performed on the values of λ¹ at x/D=0.5 for each St in each panel.

FIG. 10B shows streamwise development of modal energy gain at various St as represented by λ¹/λ¹_{x/D=0.05} for the LES data. Normalization is performed on the values of λ¹ at x/D=0.5 for each St in each panel.

FIG. 10C shows streamwise development of modal energy gain at various St as represented by λ¹/λ¹_{x/D=0.05} for the LES data by G for linear stability predictions.

FIG. 10D shows streamwise development of modal energy gain at various St as represented by λ¹/λ¹_{x/D=0.05} by G for linear stability predictions.

FIG. 11A shows the non-dimensional growth rate, —αᵢR, predicted by linear stability theory as a function of the downstream distance for n=0.

FIG. 11B shows the non-dimensional growth rate, −αᵢR, predicted by linear stability theory as a function of the downstream distance for n=|1|.

FIG. 12 shows a comparison of the modeled tan h and simulated axial velocity profile Ū(r) at different downstream distances.

Wherever possible, the same reference numbers will be used throughout the drawings to represent the same parts.

### DETAILED DESCRIPTION

A reduction in wake effects in large wind farms through wake-aware control can improve farm efficiency. The present disclosure is directed to exciting lower-order control methods with periodic pitching of the blades to produce increased modal growth, higher entrainment into the wake, and faster wake recovery. These lower order modes modify wind turbine wakes based on Strouhal numbers on the O(0.3) using the pulse method, helix method, and others). The analyses leverage the normal-mode representation of wake instabilities to characterize the large-scale wake meandering observed in actuated wakes. Idealized large-eddy simulations (LES) using an actuator-line representation of the turbine blades indicate that the n=0 and ±1 modes, which correspond to the pulse and helix forcing strategies, respectively, have faster initial growth rates than higher-order modes, suggesting these lower-order modes are more appropriate for the disclosed wake control methods.

Modal energy gain and the entrainment rate both increase with streamwise distance from the rotor until the intermediate wake. This suggests that the wake meandering dynamics, which share close ties with the relatively well-characterized meandering dynamics in jet and bluff-body flows, are an essential component of the success of wind turbine wake control methods. A spatial linear stability analysis is also performed on the wake flows and yields insights on the modal evolution. In the context of the normal-mode representation of wake instabilities, these findings represent the first literature examining the characteristics of the wake meandering stemming from intentional Strouhal-timed wake actuation, and they help guide the ongoing work to understand the fluid-dynamic origins of the success of the pulse, helix, and related methods.

The wake of a wind turbine presents complications for nearby turbines, depending on the atmospheric conditions, turbine characteristics, and turbine siting. The nascent field of wind farm flow control seeks to reduce the deleterious effects of the wake momentum deficit by leveraging the turbine as a flow actuator though the intelligent scheduling of either the blade pitch, rotor speed, or nacelle yaw. Wind farm flow control approaches fall into three categories: wake reduction (i.e., reducing the energy extraction of upstream turbines to increase the net power in the wind farm; this is commonly known as turbine derating), wake steering (i.e., deflecting the wakes of upstream turbines around downstream turbines), and wake mixing (i.e., actuating the wake periodically to increase mixing with the surrounding ambient flow). In this disclosure, a novel method of actuating the wake by periodic blade pitching alone or in combination with other wake control strategies is disclosed.

Most of the recent work on wake mixing behind wind turbines has centered around actuating the flow based on frequencies, f, scaled on the Strouhal number, St=f D/U, where D is the turbine diameter and U is the undisturbed upstream velocity usually at hub height. Note that the wake-mixing strategies considered herein target largescale flow structures and are distinct from those that target smaller-scale tip vortex phenomena. The base techniques to which periodic baked pitching is applied include the so-called pulse method, which applies an axisymmetric perturbation to the wake, and the helix method, which applies a helically winding perturbation to the wake. The blade pitch signal, θ_{b}, that produces such perturbations can be represented as in Equation (1) derived from the multi-blade coordinate (MBC) transformation,

$${θ}_{b} ( t ) = {θ}_{0} + [ \begin{matrix}1 & cos ( {ψ}_{b} ( t ) ) & sin\end{matrix} ( {ψ}_{b} ( t ) ) ] [ \begin{matrix}{θ}_{axi} ( t ) \\ {θ}_{tilt} ( t ) \\ {θ}_{yaw} ( t )\end{matrix} ] , \qquad ( 1 )$$

where subscript b denotes the blade number, θ₀ is the nominal pitch command of the controller in degrees, Φ_{b} is the blade azimuth in radians from the top-dead center, and where the quantities in the column vector are given by Equations (2)-(4)

$$\text{?} ( t ) = \text{?} sin ( \text{?} t ) \qquad ( 2 )$$

$$\text{?} ( t ) = \text{?} sin ( \text{?} t ) \qquad ( 3 )$$

$$\text{?} ( t ) = \text{?} cos ( \text{?} t ) , \qquad ( 4 )$$

$$\text{?} \text{indicates text missing or illegible when filed}$$

where A is an amplitude of the pitch perturbation in degrees, ωₑ=2π StU D⁻¹ is the temporal angular frequency of the Strouhal-scaled excitation, and t is time. The pulse method uses Aₜᵢₗₜ=A_{yaw}=0, while the helix method uses Aₐₓᵢ=0 and Aₜᵢₗₜ=A_{yaw}. The equations above produce a counter-clockwise-winding helix pattern when viewed in the same downstream direction as the flow.

These methods have been trialed both numerically and experimentally, and the results show that improvements in the power production of arrays of two or three turbines in low-turbulence environments are on the order of 1-20% depending on the inflow conditions, actuation strength, actuation strategy, and turbine layouts. Further, the helix method has been shown in some cases to outperform the pulse method, and particularly it is the counter-clockwise-winding helix that performs most favorably. Another variation of the helix method is pure side-to-side or up-and-down forcing, which can be applied to the wake by retaining only the θ_{yaw}(t) and θₜᵢₗₜ(t) terms in Equation (1). An early study by Frederik et al. (Frederik, J.; Doekemeijer, B.; Mulders, S.; van Wingerden, J. W. On wind farm wake mixing strategies using dynamic individual pitch control. In Proceedings of the Journal of Physics: Conference Series; IOP Publishing: Bristol, U K, 2020; Volume 1618, p. 022050) considered these cases, finding the up-and-down forcing produced better wake recovery than the side-to-side forcing. The fluid-dynamic understanding of the causes for the results above are not well known.

Korb et al. (Korb, H.; Asmuth, H.; Ivanell, S. The characteristics of helically deflected wind turbine wakes. J. Fluid Mech. 2023, 965, A2) likely represent the most advanced work to date dissecting the mechanisms at play in the helix method. They pinpoint two different mechanisms by which the helix method affects the wake: (1) through deflection of the wake center, which reduces the overlap of the wake with potential downstream turbines and consequently increases the kinetic energy available to the downstream turbine, and (2) through increased meandering in the far wake, which has the same effect. Note that while wake meandering is sometimes used to refer to the movement of the wake as a passive tracer under the influence of large atmospheric flow structures, the periodic Strouhal-based oscillation of wakes has been observed irrespective of inflow dynamics, and it is this mechanism that is referred to as wake meandering in Korb et al. and in this disclosure as well.

Although Korb et al. suggest that the far wake meandering effect of the helix method on wake mixing is the less prominent of the two effects listed above, the present work shows that it may play a larger role than suggested. This assertion stems from the history of work on wake meandering both in wind energy and adjacent applications of fluid dynamics.

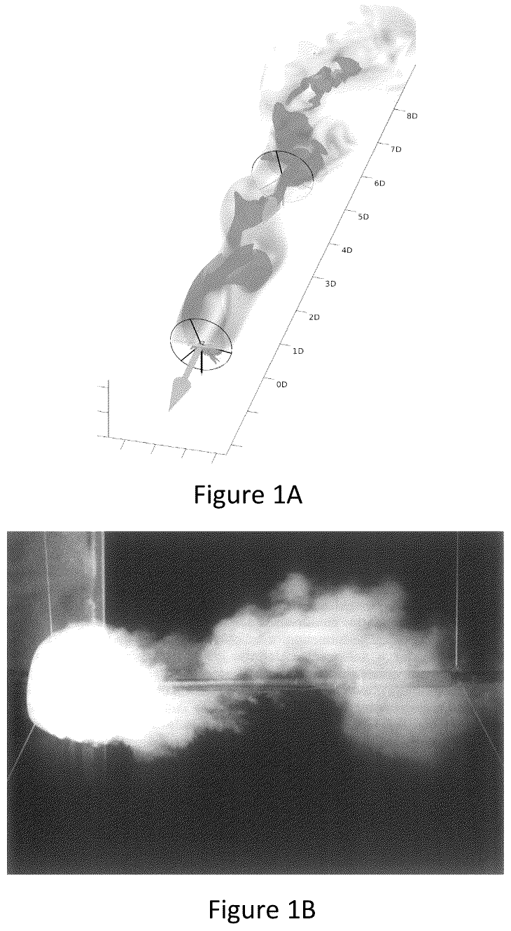

The first reported mention of a Strouhal-scaled unsteadiness behind a wind turbine was Medici and Alfredsson (Medici, D.; Alfredsson, P. H. Measurements on a wind turbine wake: 3D effects and bluff body vortex shedding. Wind Energy 2006, 9, 219-236), who found St≈0.1-0.3 similar to the St≈0.2 observed behind bluff bodies due to periodic vortex shedding. Okulov et al. (Okulov, V.; Naumov, I. V.; Mikkelsen, R. F.; Kabardin, I. K.; Sørensen, J. N. A regular Strouhal number for large-scale instability in the far wake of a rotor. J. Fluid Mech. 2014, 747, 369-380) and lungo et al. (Iungo, G.; Viola, F.; Camarri, S.; Porté-Agel, F.; Gallaire, F. Linear stability analysis of wind turbine wakes performed on wind tunnel measurements. J. Fluid Mech. 2013, 737, 499-5260) provided significantly more insight on this mechanism; Okulov et al. found that for various wind turbine rotor regimes the St is tied to large-scale, unstable, meandering structures in the far wake involving the precession of a helical vortex core, and lungo et al. similarly measured evidence that the most amplified frequency in the wake of a turbine model was that of a counter-winding helical structure. Drawing on studies of fluid dynamics behind bluff bodies, Okulov et al. compared the helical structure observed behind the wind turbine rotor disk to the shed vorticity in the wake of a sphere where the vorticity is released from a point that moves along the surface at a shedding frequency that generates either a single or double helical structure. Note that this helical phenomenon is present in high Reynolds number flows behind axisymmetric bodies of various types, including behind disks and porous disks, geometries which are similar to the wind turbine rotor disk. A comparison of the antisymmetric helical structure produced by a nutating disk (i.e., a disk oscillating similarly to the motion of a swashplate) and by a wind turbine using the helix method is shown in FIG. 1. Note that in the case of the disk, coherent helical structures naturally exist when the disk is at rest though their appearance is stochastic; applying the nutation motion “locks in” the structure to be stabilized in space and time.

The mathematical underpinnings to analyze such vortex shedding and subsequent flow structures have been well studied in the literature for free shear-flow instabilities related to wake and jet flows. In the classical linear stability approach, the time-varying perturbations, \tilde{χ}=(ũ, \tilde{ν}, \tilde{w}, \tilde{p}), to the mean flow field are assumed to be initially small but can develop spatially or temporally depending on the wavelength and frequency of the excitation. These analyses generally assume a normal-mode representation for the perturbations with a temporal angular frequency ω, spatial wavenumber α, and azimuthal index n as a function of the cylindrical polar coordinates (x, r, ϕ):

$$\text{?} ( x , r , ϕ , t ) = \text{?} ( r ) \text{?} . \qquad ( 5 )$$

$$\text{?} \text{indicates text missing or illegible when filed}$$

Here, ϕ_{clock} defines a clocking angle to adjust the orientation of the eigenfunction \hat{χ}ₙ, where ϕ_{clock}=0 corresponds to the vertical direction and ϕ_{clock}=π/2 corresponds to the horizontal direction. Using some assumptions regarding the parallel flow or inviscid nature of the problem, this expansion in the governing equations generally results in an eigenvalue equation that can be solved to find the most unstable disturbances in the flow.

Some characteristics that emerge from such spatial stability analyses, as well as from numerical and experimental studies on jet and wake free shear flows alike, are that the optimal w's scale on U/D (i.e., Strouhal scaling) and axisymmetric perturbations (i.e., n=0) often produce lower growth rates than perturbations of the first helical modes (i.e., n=±1). For swirling flows, there is a preferential direction of the first helical mode to produce the largest growth rate of the instability structure. The second helical modes also become more relevant for swirling jet flows. Except for the findings related to the second helical modes (i.e., n=±2), which have not been intentionally forced in wind turbine wakes, these observations corroborate the findings surrounding the pulse and helix methods as well as those from Medici and Alfredsson and Okulov et al. and suggest that there may be a significant overlap of the physics of large-scale shear-flow instabilities between bluff-body wakes, jet flows, and wind turbine wakes, and are distinct from the physics of smaller-scale structures connected to the tip vortex instabilities.

### Control of Large-Scale Shear-Flow Instabilities

The elegance of large-scale shear-flow structures from a flow-control perspective is their convectively unstable nature, i.e., they naturally grow in magnitude as the flow is convected. This suggests that a small actuation force near the wake origin might be leveraged to produce a large-scale mixing effect in the far wake, a characteristic that has been leveraged for control purposes in the literature from jet and bluff-body flows. For instance, Ho and Huerre (Ho, C. M.; Huerre, P. Perturbed free shear layers. Annu. Rev. Fluid Mech. 1984, 16, 365-424) and Crow and Champagne (Crow, S. C.; Champagne, F. Orderly structure in jet turbulence. J. Fluid Mech. 1971, 48, 547-591) demonstrated that the excitation of large-scale coherent structures at the jet inlet can lead to large changes in the mean profile downstream, and the growth of the vortical structures is key to understanding this behavior. Furthermore, theory, simulation, and experiment have also suggested that the excitation of the first positive and negative helical modes (termed here the double-helix method) has a strong potential for increasing the mixing of the flow, such as in the case of bifurcating jets or capillary jet instabilities.

It remains to be seen how the fluid-dynamic understanding of shear-flow instabilities and their control as derived from studies of canonical wake and jet flows can be applied to the wind turbine case beyond what has already been accomplished in the studies of the pulse and helix methods. Wind turbine wakes vary from canonical bluff-body wakes, for instance, because of differences in the geometry of the wake-producing element, the presence of non-uniform and unsteady inflow, and the presence of swirl in the wake.

The existing work in the wind energy and water power communities that has begun to study the control of shear-flow instabilities from a fundamental perspective include Mao and Sorensen (Mao, X.; Sørensen, J. Far-wake meandering induced by atmospheric eddies in flow past a wind turbine. J. Fluid Mech. 2018, 846, 190-209), Gupta and Wan (Gupta, V.; Wan, M. Low-order modelling of wake meandering behind turbines. J. Fluid Mech. 2019, 877, 534-560), and Li et al. (Li, Z.; Dong, G.; Yang, X. Onset of wake meandering for a floating offshore wind turbine under side-to-side motion. J. Fluid Mech. 2022, 934, A29). These authors analyzed the stability of wind turbine wakes to identify the Strouhal range and azimuthal mode numbers most relevant to wind turbines. Mao and Sorensen numerically studied the flow past a wind turbine at a reduced Reynolds number and with oscillating inflow perturbations and found the n=1 mode to be most energetic in the wake with a dominant St of 0.16. Gupta and Wan similarly used large-eddy simulation (LES) and harmonically oscillating inflow to show that the dominant frequency falls as the wake flow convects farther downstream, and this behavior was ascribed to the broadening of the velocity deficit, which affects the stability characteristics. Li et al. studied a floating offshore turbine with perturbations imposed through the side-to-side motion of the wind turbine to simulate wave-induced turbine movement. They used a linear stability analysis and LES to demonstrate that wake meandering can be triggered with side-to-side motions in the St range of 0.2-0.6. Mao and Sorensen, Gupta and Wan, and Li et al. all observed the dominant frequency to decrease as the magnitude of the inflow perturbations increases, and Li et al. noted that the amplification of the modes decreases as this magnitude increases, as well. Though not performing a stability analysis, Hodgson et al. (Hodgson, E.; Madsen, M. A.; Troldborg, N.; Andersen, S. Impact of turbulent time scales on wake recovery and operation. In Proceedings of the Journal of Physics: Conference Series; IOP Publishing: Bristol, U K, 2022; Volume 2265, p. 022022) used LES to model the flow over a rotor with inflow perturbations that correspond to an St range of 0.14-0.25. The observed increase in mean kinetic energy transport into the perturbed wake in Hodgson et al. and the corresponding significant increases in the power output of virtual downstream turbines lends credence to the previous assertion that Strouhal-based wake excitation and the subsequent meandering play a prominent role in the success of the pulse and helix methods. Further, the velocity fluctuations at excited St values in Hodgson et al. and Mao and Sørensen grow around an order of magnitude larger from the inflow to the far wake (i.e., the amplification factor is ˜10), which suggests the usefulness of shear-flow instabilities to effect large changes in wind turbine wakes at the price of potentially only a small actuation input.

The existing work in the previous paragraph stops short of analyzing the wake meandering behind a wind turbine in the case of the intentional actuation of the Strouhal-based instabilities using the turbine itself. Drawing on inspiration from the existing work in the wind turbine community and from adjacent fluid-dynamics communities for jet and bluff-body flows, we report for the first time in the literature the characteristics of the periodic wake meandering of the pulse- and helix-actuated methods in wind turbine wakes from a normal-mode perspective, doing so with both qualitative and quantitative methods, as well as relate for the first time this wake meandering growth to conventional quantities of interest. Further, we revisit the double-helix method for wind turbine wake control as inspired by the work on jet flows and as initially trialed for wind turbine flows in the early study by Frederik et al.

The following is organized as follows. Formulation of Blade Forcing introduces the formulation used for the blade forcing, Computational Setup introduces the LES setup, Numerical Results and Analyses offers the numerical results, Insights from Linear Stability Theory gives insights on the wind turbine wake meandering derived from the linear stability analyses, and later sections draw on conclusions and summary and embodiments of the disclosure.

### Formulation of Blade Forcing

The normal-mode representation for the wake flow perturbations as introduced above in Equation (5) can be readily adapted into the rotating frame and offers flexibility in specifying the forcing strategy. In this article, we choose to use this representation rather than the MBC transform of Equation (1), although both methods produce equivalent results. For each blade bⱼ, we compute the total phase angle, P_{b,j}, of the blade pitch excursion for a given mode index, j, according to Equation (6),

$${P}_{b , j} ( t ) = \text{?} t - {n}_{j} ( {ψ}_{b} ( t ) + {ϕ}_{clock} ) . \qquad ( 6 )$$

$$\text{?} \text{indicates text missing or illegible when filed}$$

Next, the phase angle is converted into the complex pitch amplitude, Ã_{b}, according to Equation (7),

$$\text{?} ( \text{?} ) = A \text{?} , \qquad ( 7 )$$

$$\text{?} \text{indicates text missing or illegible when filed}$$

where i=\sqrt{−1} and the pitch amplitude of each mode to be superimposed is A, which is optionally left outside the summation to reflect the constant amplitude cases examined herein. Finally, the real pitch amplitude, θ_{b}(t), to be passed to the next step of the controller is calculated according to Equation (8),

$${θ}_{b} ( t ) = {θ}_{0} + ℝ ( \text{?} ( t ) ) . \qquad ( 8 )$$

$$\text{?} \text{indicates text missing or illegible when filed}$$

To help with the interpretation of the equation, we insert Equation (6) into Equation (7), insert that result into Equation (8), apply Euler's formula, and extract the real-valued component. The result is Equation (9),

$$\text{?} ( \text{?} ) = \text{?} + A \text{?} cos ( \text{?} - \text{?} + \text{?} ) ) . \qquad ( 9 )$$

$$\text{?} \text{indicates text missing or illegible when filed}$$

Equation (9) indicates that individual normal modes contribute harmonic content at distinct frequencies to θ_{b}(t).

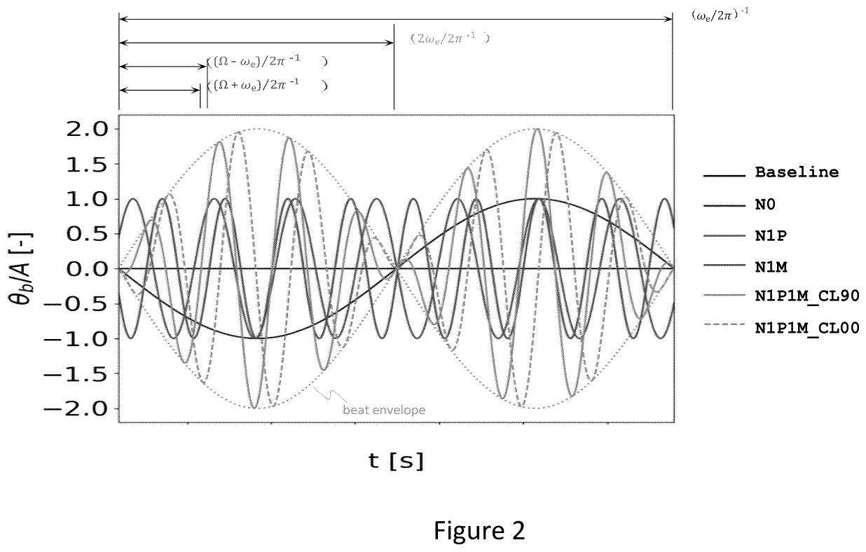

Table 1 provides a list of some different forcing schemes examined. Simulations were run in which a single azimuthal mode, either n=0, +1, −1, was excited, as well as cases in which two opposing modes, the n=+1 and n=−1, were simultaneously excited. FIG. 2 shows an example of the blade pitch signals for the cases in Table 1. For the single-mode cases of n=+1 and n=−1, the frequency of the blade pitching is near to the rotor shaft frequency since ψ_{b}(t)=Ωt+ψ_{0,b} (where Ω is the shaft frequency and ψ_{0,b} is the azimuthal offset of blade b from blade 1) and Ω>>ωe, at least for cases where we is based on a large-scale shear-flow instability St value. For the double-mode n=±1 cases, the two frequencies from the single-mode cases of n=+1 and n=−1 are superimposed in θ_{b}(t) according to Equation (9). This superposition creates the existence of a beat frequency, which oscillates at 2ωₑ. At the peak of the beat, θ_{b}(t) becomes the sum of amplitudes from each mode, so the total amplitude of θ_{b}(t) for these cases is double that for the cases with only one forced mode, and the total pitch travel is also increased. For the single-mode case of n=0, the frequency of θ_{b}(t) is much lower than for the other cases because the second term under the cosine in Equation (9) becomes zero.

TABLE 1
Table of different forcing schemes tested in this study. Note that the
amplitude of pitch forcing in all cases was A = 0.5°.

| | Azimuthal | Clocking | |
|---|---|---|---|
| Case | Modes, n | Angle, φ_{clock} | Description |
| Baseline | N/A | N/A | no forcing |
| N0 | 0 | 90° | axisym, (i.e., pulse) |
| N1P | +1 | 90° | CW helical |
| N1M | −1 | 90° | CCW helical |
| N1P1M_CL90 | +1, −1 | 90° | side to side |
| N1P1_CL00 | +1, −1 | 0° | up and down |

### Computational Setup

The simulations in the current work are performed using the ExaWind/Nalu-Wind LES flow solver coupled with OpenFAST to model the aero-elastic behavior of the wind turbine. The Nalu-Wind solver (Domino, S. Sierra Low Mach Module: Nalu Theory Manual; SAND2015-3107W; Unclassified Unlimited Release (UUR); Sandia National Laboratories: Albuquerque, NM, USA, 2015) is based on an unstructured, node-centered finite volume approach to solve the incompressible Navier-Stokes equations with a low-Mach number approximation using an implicit BDF2 time-stepping algorithm. In all simulations, the subgrid-scale kinetic energy one-equation turbulence model was used for turbulence closure. Nalu-Wind has been previously used to model the Cape Wind offshore ABL under various atmospheric conditions, as well as for turbine wake studies in onshore wind farms.

An actuator-line representation, coupled with the OpenFAST turbine simulation code, was used to model the effects of the wind turbine blades on the fluid. The control of the wind turbine and the desired pitch actuation was governed by the Reference Open-Source Controller (ROSCO) and capable of pitching each blade independently based on the azimuthal location and a predefined frequency.

The wind turbine model used to demonstrate the wake control theory is based on the publicly available IEA 3.4-130 reference model, which was scaled to match the general characteristics of the GE 2.8-127 turbine (see Table 2). The inflow conditions for this study were chosen to correspond to the region 2 behavior of the turbine where the nominal blade pitch remains constant. Unless otherwise noted, we used a hub-height wind speed of 6.4 m/s with a shear exponent of α=0.169 and neutral atmospheric stratification with no veer. For the ease of analysis and to isolate the behavior of the structures that appear in the turbine wakes, steady inflow conditions were used with no inflow turbulence.

TABLE 2
Characteristics of the OpenFAST wind turbine in the
current study. These parameters were created by scaling
an IEA 3.4-130 reference turbine to match the general
characteristics of the GE 2.8-127 turbine.

| Parameter | Value | |
|---|---|---|
| Rotor diameter | 127 | m |
| Hub height | 90 | m |
| Rated power | 2.8 | MW |
| Rated wind speed | 10.7 | m/s |
| Rated rotor speed | 12.8 | rpm |

| | |
|---|---|
| Tip-speed ratio | 8.0 |

The overall simulation domain was approximately 40.3 D×15.1 D×7.6 D in the streamwise, lateral, and vertical dimensions, respectively, with a total mesh size of 21.8 million elements. The grid resolution was 20 m in the freestream and was successively refined to be 1.25 m near the turbine rotor. At the upper and lower surfaces, a slip boundary condition was imposed, while there were periodic boundary conditions in the lateral boundaries. An outflow pressure boundary condition was used at the outlet surfaces, and the inlet boundary used a mass inflow boundary with the specified power-law velocity profiles. In all simulations, a time step of 0.015 s was used and typically computed using 1024-1152 cpu cores with 2.6 GHZ Intel Sandy Bridge processors for at least 96 h of wall time.

The simulations used a power-law velocity as the initial condition and the runs included a transient initialization time of more than 9 min based on the duration required for the power output of the turbine to stabilize. The flow statistics were then accumulated at more than 2 Hz over a duration of 265 s, which corresponds to four periods at ωₑ=0.095 rad/s, or St=(2π)⁻¹ ωₑD/U_{hub}=0.3. The applied St was 0.3 unless otherwise noted, and the pitching amplitude per mode, A, was 0.5°.

### Numerical Results and Analyses

Using the outputs of the LES and OpenFAST simulations discussed under Computational Setup, a series of analyses can be performed to explore the mechanisms of the wake modification and determine their effectiveness. As discussed in subsequent sections, these analyses focus on the following items:
Using blade loading results to determine the actuation authority.
Applying a modal POD analysis to calculate the energy growth of specific flow structures.
Calculating momentum entrainment through the radial shear stress flux.
Using a linear stability analysis to analyze the behavior of the excited instability modes.

### Actuation Authority Via Individual Pitch Control

Given the forcing schemes outlined in Table 1, it is of particular interest to determine whether the individual blade pitch actuation leads to the excitation of the correct azimuthal perturbations at the appropriate levels even in the presence of realities, such as the inflow shear and shaft tilt. Although the exact pitch amplitude to be employed depends on both the blade geometry and the ambient turbulent intensity in the atmospheric boundary layer, we can confirm that the blade pitch fluctuations lead to the appropriate loading response by examining the azimuthal and temporal variation in the axial blade loading.

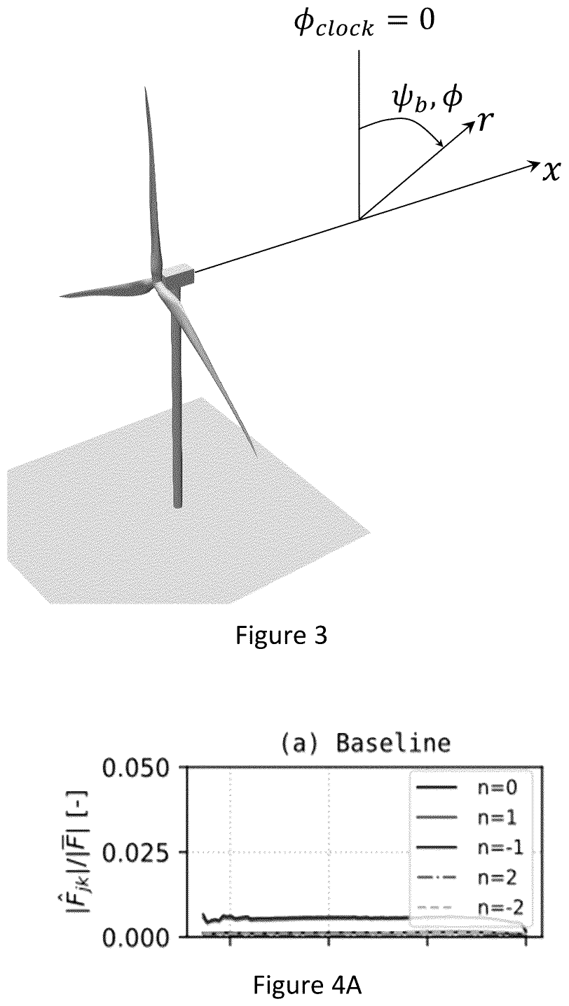

Since the out-of-plane force, F, depends on the radial location r, azimuthal angle ψ_{b}, and time t (see FIG. 3), we assume that it can be decomposed into the form in Equation (10),

$$F ( r , {ψ}_{b} , t ) = \sum \text{?} ( r ) \text{?} , \qquad ( 10 )$$

$$\text{?} \text{indicates text missing or illegible when filed}$$

where k is a frequency index and j is again an azimuthal index. Note that F (r, ψ_{b}, t) follows the blade and thus is not a full-field quantity that exists at every position in space and time on the rotor plane. Given a simple time series at every blade nodal location, special consideration therefore is needed to calculate \hat{F}ⱼₖ as explained below.

In the limit of the constant rotor speed operation, we can define ψ_{b(t)}=Ωt+ψ_{0,b} as before and combine this with an effective frequency, ω′ⱼₖ=ωₖ−nⱼΩ. For the case of blade 1, inserting the above relation into Equation (10) yields Equation (11)

$$F ( r , {ψ}_{b} , t ) = \sum {\hat{F}}_{jk} ( r ) \text{?} \qquad ( 11 )$$

$$\text{?} \text{indicates text missing or illegible when filed}$$

so that \hat{F}ⱼₖ can be calculated through a simple Fourier transform of the blade loading signal.

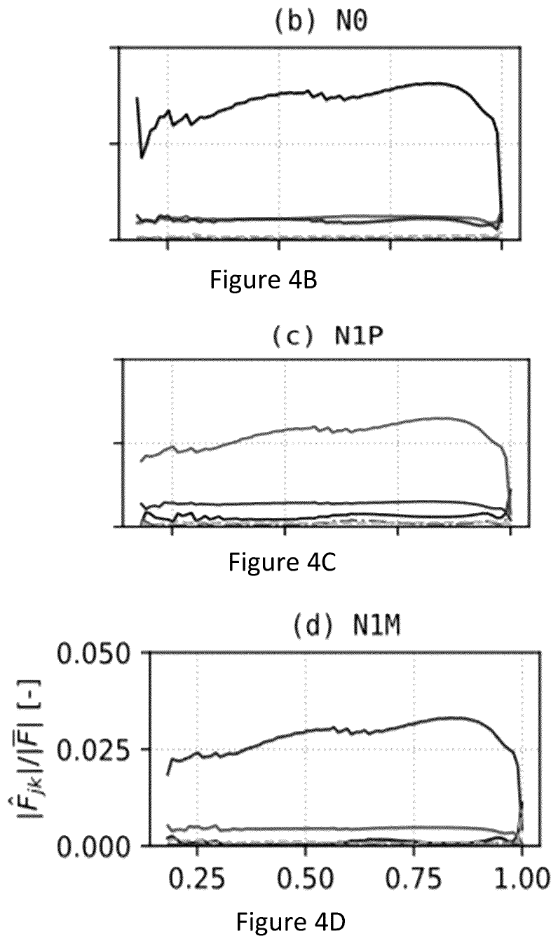

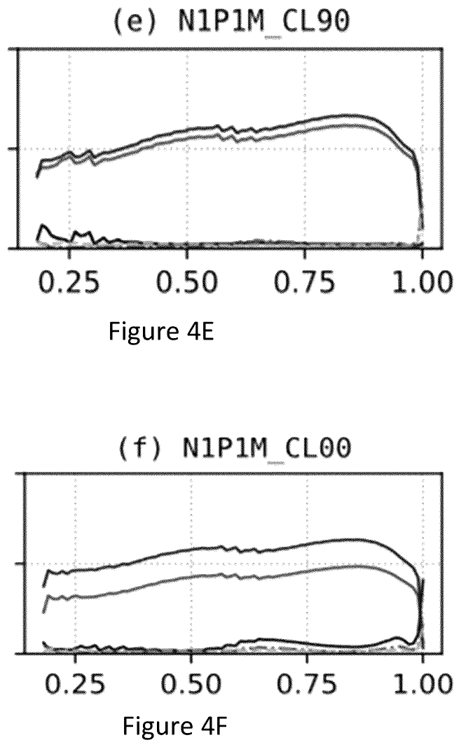

The results are shown in FIG. 4 where a forcing strategy using A=0.5° leads to an axial blade loading variation of approximately 1-2% in all cases, with the largest loading variations seen near the tip section of the blade. This suggests that a reasonable level of initial perturbations can be excited at the rotor disk without incurring turbine damage from large blade pitch fluctuations, at least for cases with low inflow turbulence. In cases where both the n=+1 and the n=−1 modes are forced simultaneously, the axial blade load variation remains generally above 1% for each corresponding azimuthal mode, but the response at n=+1 is not identical to that at n=−1. This imbalance between the excited modes may be caused by the existing shaft tilt or interactions with the blade rotation and mean wind shear and may lead to differences in downstream wake behavior, as discussed in the sections below. In general, however, FIG. 4 suggests that the appropriate modes are being perturbed by each respective case and further that no extraneous modes are being perturbed.

Note that the above analysis was conducted using a steady mean flow with no inflow turbulence in order to clearly demonstrate the effects of the actuation strategy. In the presence of atmospheric turbulence and unsteady inflow, the blade loading can become more complicated. Large-scale structures that are present in the atmospheric boundary layer can introduce additional loading for the n=0 or n=+1 azimuthal modes at the actuation Strouhal number.

### Tracking of Meandering Instabilities

### Structure Visualization

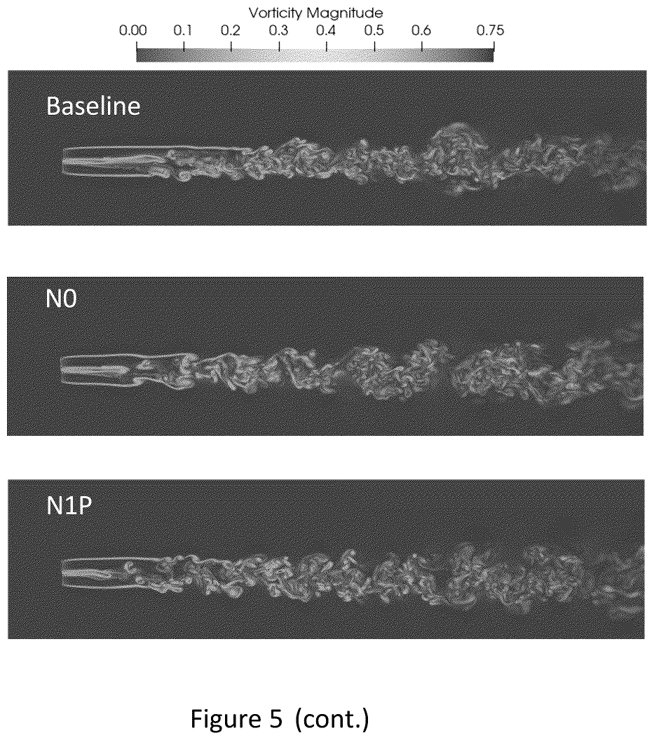

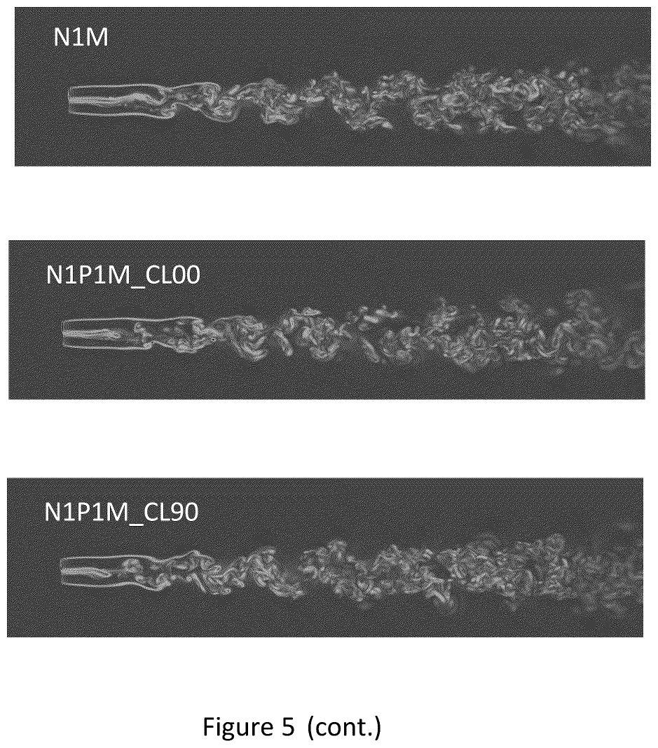

The evolution of the perturbed large-scale structures and the differences between the modal forcing approaches are readily apparent in the visualizations of the computed turbine wakes. For instance, in FIG. 5, the hub-height contours of the out-of-plane vorticity magnitude are displayed for all cases. The structures are analogous to the largescale coherent structures observed in previous studies on instability wave excitations in jets. For the forced cases, the development of vortical structures and the breakdown of the wake occur at earlier downstream locations compared to the baseline case. For the N0 case, organized vortical ring structures appear in the turbine wake, while for the N1P and N1M cases, the azimuthal forcing produces helical structures, which appear most coherent for the N1M case. When the turbine blades are forced at both the n=+1 azimuthal modes for the N1P1M_CL90 case, a side-to-side flapping motion of the wake can be seen, and the vortical structures appear earlier than any of the other cases.

### Modal Decomposition

A more quantitative perspective of the growth of large-scale flow-field structures is afforded by modal decomposition. Our approach follows directly from that of Citriniti and George (Citriniti, J. H.; George, W. K. Reconstruction of the global velocity field in the axisymmetric mixing layer utilizing the proper orthogonal decomposition. J. Fluid Mech. 2000, 418, 137-166). The decomposition is applied to the streamwise component of the velocity on cross-stream planes. First, the velocity field is Fourier-decomposed in the stationary and homogeneous (i.e., temporal and azimuthal, respectively) dimensions, followed by a proper orthogonal decomposition (POD) in the non-homogeneous (i.e., radial) dimension. The POD is applied across the radial dimension from the axis of the turbine rotation to a radius of 1.4 times the rotor radius, and this allows for the flow dynamics near the wake edges to be captured even as the wake spreads. This approach assumes that the wake center remains on the axis of rotation. For the temporal decomposition, a single block is used with the record length corresponding to all 588 samples after the 9 min of transient initialization described previously. The eigenvalue problem at each streamwise position therefore produces a series of eigenvalues, λ¹, that indicate the relative turbulent energy per mode at that streamwise position.

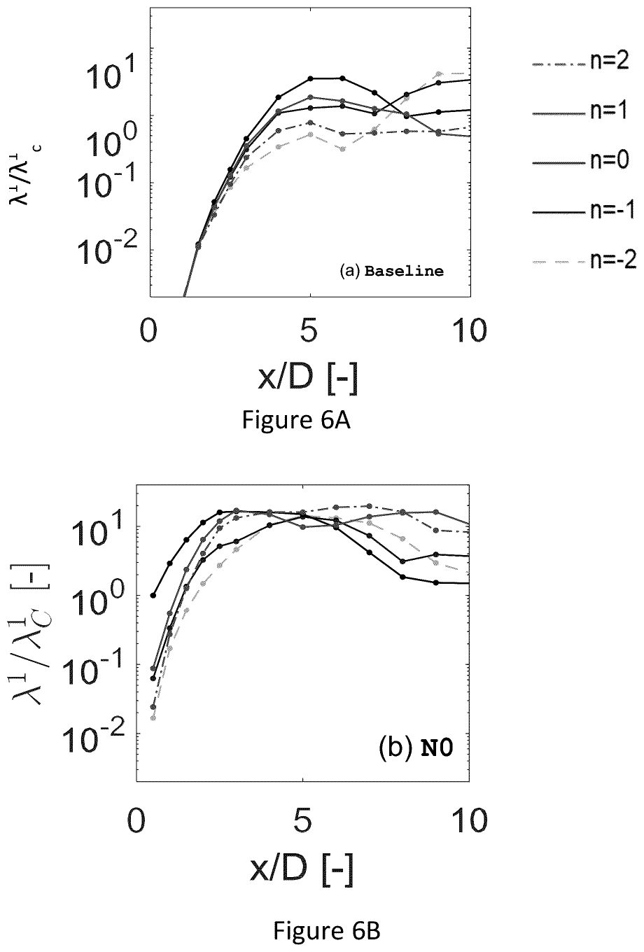

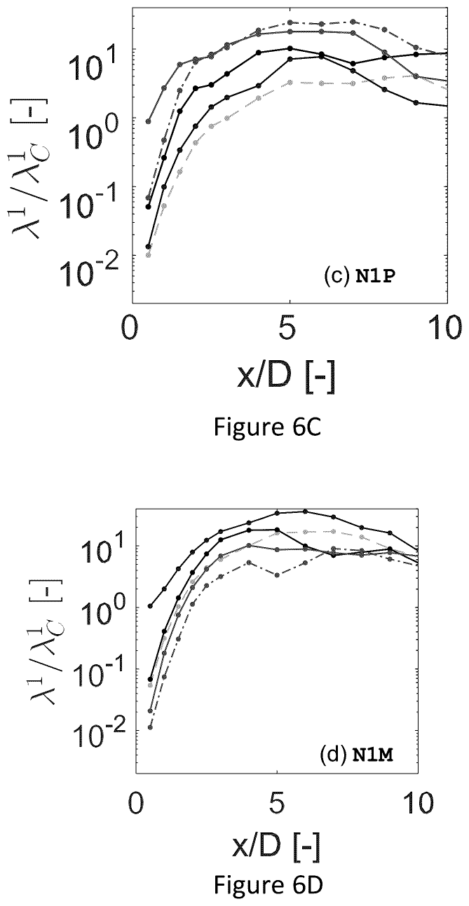

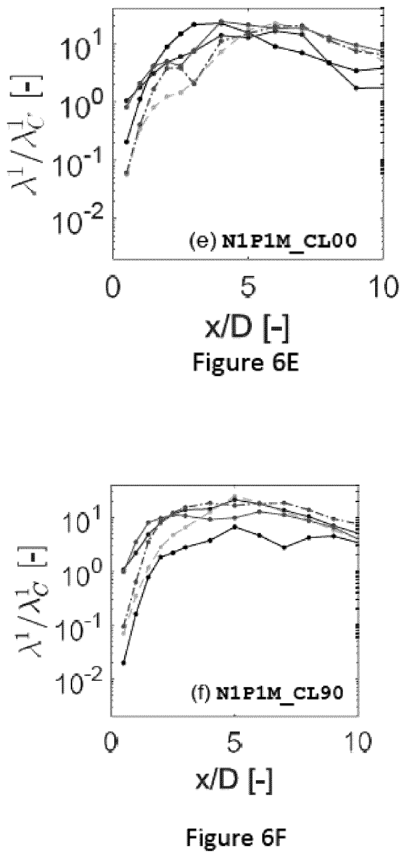

FIG. 6 shows the modal growth versus x/D. Approximately linear growth is observed until x/D≈1.5-2, after which nonlinear effects become prominent. In agreement with the previous literature on the related free shear flows, the baseline case shows markedly larger growth rates for the n=0, +1, and −1 modes with progressively decreasing rates for the higher modes. The ordering of these three fastest growing modes differs slightly from expectations from the jet flow literature with the n=0 being most unstable in this case, followed closely by the n=+1 and −1 modes. For the cases with intentional forcing, the highest magnitude mode of any case is reached by the N1M case in FIG. 6D. In an otherwise axisymmetric flow, the N1P and N1M cases would be expected to have the same growth trajectory of their respective forced modes, but the presence of swirl in our flow is believed to be responsible for the larger overall growth of the n=−1 mode. This observation hints at a fluid-dynamic explanation for why the counterclockwise helix forcing strategy for wind turbine wakes has been more successful than its clockwise counterpart as reviewed above. In all the forced cases, the n=0, +1, and −1 modes peak by x/D=6, though the local maxima also occur further downstream in several cases.

The streamwise development of the modal amplitudes also shows evidence of modal interactions and nonlinear energy exchange. While only the n=0 mode is explicitly excited in the N0 case (FIG. 6B), the growth of the first helical n=+1 and n=−1 modes and second helical n=+2 mode is still present and can reach amplitudes comparable to the n=0 mode. The converse situation occurs for the N1P1M_CL00 case (FIG. 6e), where the axisymmetric mode grows despite only the n=+1 modes being explicitly forced. This growth of higher harmonics and higher helical modes is an expected result of triadic interactions between instability modes and has been previously studied in mixing layers and jets. For example, in the N1PIM_CL00 case, the interactions of the n=+1 and St=0.3 mode with the n=+1 mean mode (i.e., St=0.0) can lead to the growth of the n=+2 mode at the fundamental frequency. While these interactions cannot be directly captured through a purely linear stability analysis (as described further below), more accurate predictions of mode competition can be achieved through approaches, such as the nonlinear parabolized equations.

### Conventional Quantities of Interest

A consequence of the growth of the modes described above is an increase in the turbulent entrainment by the wake, especially at the wake boundaries. This entrainment is here quantified using the radial shear stress flux, ūₓu̅′̅ₓ̅u̅′̅ᵣ̅, where ūₓ is the mean streamwise velocity and where u̅′̅ₓ̅ and u̅′̅ᵣ̅ are the fluctuating components of the velocity in the streamwise and radial directions, respectively. Lebron et al. (Lebron, J.; Castillo, L.; Meneveau, C. Experimental study of the kinetic energy budget in a wind turbine streamtube. J. Turbul. 2012, 13, N430) and Boudreau and Dumas (Boudreau, M.; Dumas, G. Comparison of the wake recovery of the axial-flow and cross-flow turbine concepts. J. Wind Eng. Ind. Aerodyn. 2017, 165, 137-152) indicate that this radial turbulent transport is the dominant contributor to wake recovery for all locations downstream of the tip vortex breakdown.

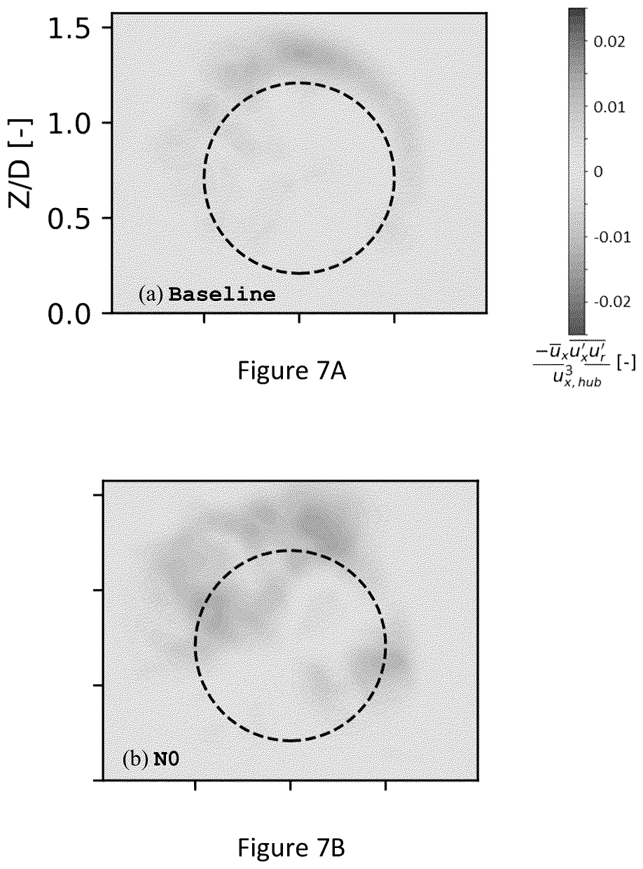

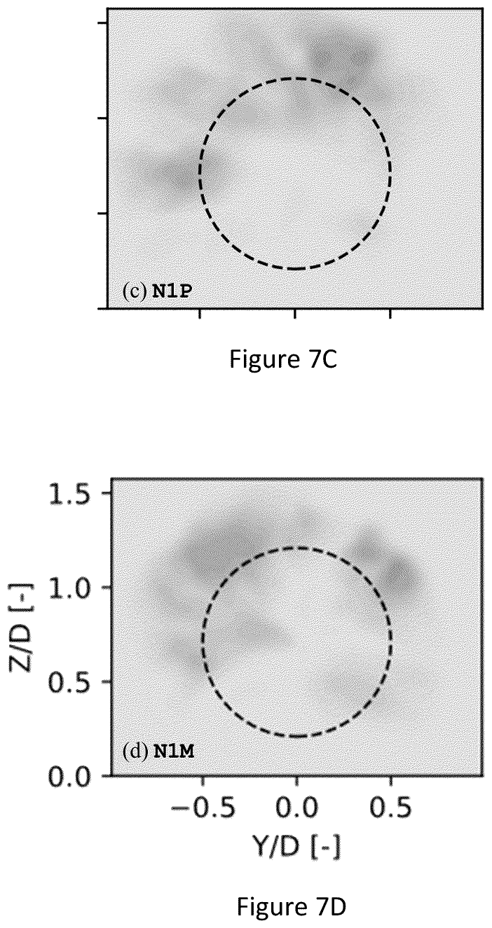

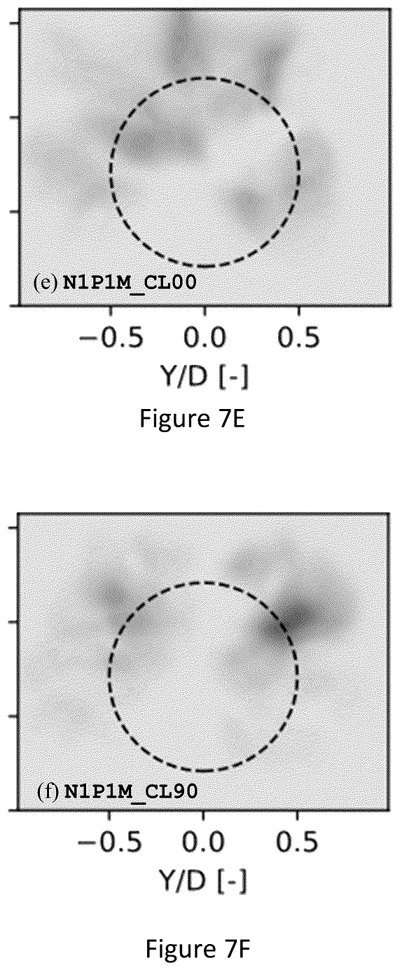

FIG. 7 shows cross-sections in the yz plane of −ūₓu̅′̅ₓ̅u̅′̅ᵣ̅ for a distance 7D downstream from the rotor. At this distance, the stability modes and large-scale coherent structures arising from the forcing are more developed, and their impact on the wake behavior is more discernible. The effect of the wake-mixing strategies is to increase the transport of the mean flow kinetic energy back into the rotor-swept area as indicated by the more positive values of −ūₓu̅′̅ₓ̅u̅′̅ᵣ̅ for FIGS. 7B-7F as compared to FIG. 7A. The cases with forcing of the n=±1 modes demonstrate expected directional behavior with an apparent axis of roughly up-and-down and side-to-side fluxes appearing in the wakes in FIGS. 7E and 7F, respectively. The non-perpendicularity of these axes between FIGS. 7E and 7F could be a result of the imbalance between the realized excitation levels of the n=+1 and n=−1 modes as discussed for FIG. 4.

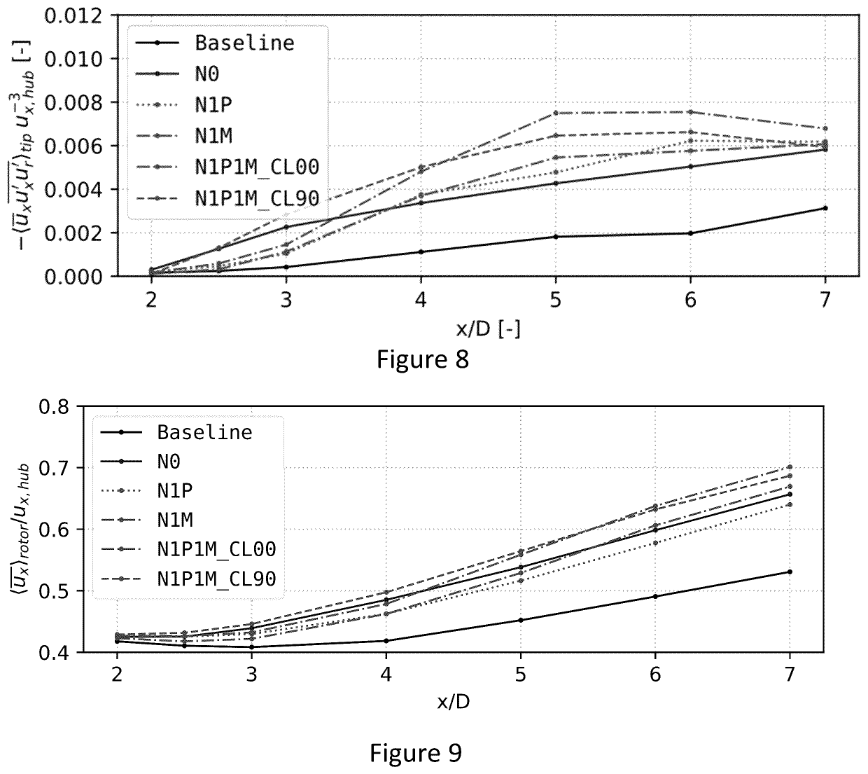

Quantitative tracking of the transport in the mean flow kinetic energy in FIG. 7 can be achieved by averaging −ūₓu̅′̅ₓ̅u̅′̅ᵣ̅ along the circle projected from the blade tips. FIG. 8 shows this result. For all the actuated cases, there is little turbulent entrainment in the near wake and stronger entrainment in the far wake. This observation corroborates the argument above that the wake meandering phenomenon, which begins with small, unstable perturbations that grow into large-scale structures, is a relevant and maybe dominant mechanism in the recovery of wakes actuated with axisymmetric or helical modes. This averaged radial shear stress flux can be linked to additional quantities of interest, particularly the rotor-averaged velocity available downstream energy, as discussed below.

The most practical effect of the increases in the modal growth and turbulent entrainment due to intentional forcing may be the increases in the velocity recovery downstream of the rotor. FIG. 9 demonstrates such increases using the metric of the rotor-averaged axial velocity, (ūₓ)ᵣₒₜₒᵣ, which is the mean velocity taken over the projected area of the rotor disk at different downstream locations. The N1P and N1M cases begin with relatively lower velocity recovery, but the N1M case outpaces the N1P case and eventually the N0 case by x/D=6. The linear superposition of the n=+1 and n=−1 in the N1P1M_CL00 and N1P1M_CL90 cases produces an increase in far-wake recovery, especially for the former. The success of the N1P1M_CL00 case compared to the N1PIM_CL90 case agrees with the results of Frederik et al. and could be a consequence of the vertical flapping motion having greater efficacy at drawing high-momentum fluid from aloft down toward the rotor height.

This success of the N1P1M_CL00 case is especially notable considering that the actuation authority of this case is lower than the N1P1M_CL90 case in FIG. 4, and more investigation is warranted to determine if the performance of the N1P1M_CL00 case could be increased through improved actuation authority. Across all the cases, the increase in the rotor-averaged velocity relative to the baseline at a downstream distance of 7D, which might be considered a hypothetical position for siting a downstream turbine, is 20-32% of the hub-height inflow velocity depending on the forcing scheme. This increase in the rotor-averaged velocity directly translates to a higher possible energy capture for the downstream wind turbine or higher-density wind farm layouts, although additional studies are required across multiple wind conditions before the result can be applied in practice.

It should be noted that additional metrics for determining the impact of flow structures on the wake evolution are also available. For instance, the integrated momentum thickness and vorticity thickness have been shown to be well correlated to vortex pairing and coherent structure formation in jets and mixing layers. While these measures are less directly connected to the available wind energy for downstream wind turbines, they may yield additional insights into the wake structures and are worth considering in future studies.

Insights from Linear Stability Theory

The behavior of the excited instability mode and its dependence on the excitation Strouhal number is an important consideration when optimizing the forcing for the maximum possible wake benefit. In the previous sections, the wake and turbine results for an excitation Strouhal number of St=0.30 were shown for various azimuthal forcing strategies. In the next section, we discuss how the choice of frequency modifies the instability mode behavior and link the results to linear stability theory.

A similar computational approach was adopted to study the effectiveness of the excitation frequency, where blade pitch fluctuations are applied to a representative GE 2.8-127 turbine model. For simplicity, a uniform flow of 6.4 m/s with no shear and no ground effect was considered, and only the individual n=0 and n=−1 azimuthal forcing modes were used. However, in these cases, the Strouhal number forcing varied from St=0.225 to St=0.45. The downstream energy content of the instability modes was then again calculated through Fourier decomposition, azimuthal decomposition, and POD, as described in Section 4.2.2.

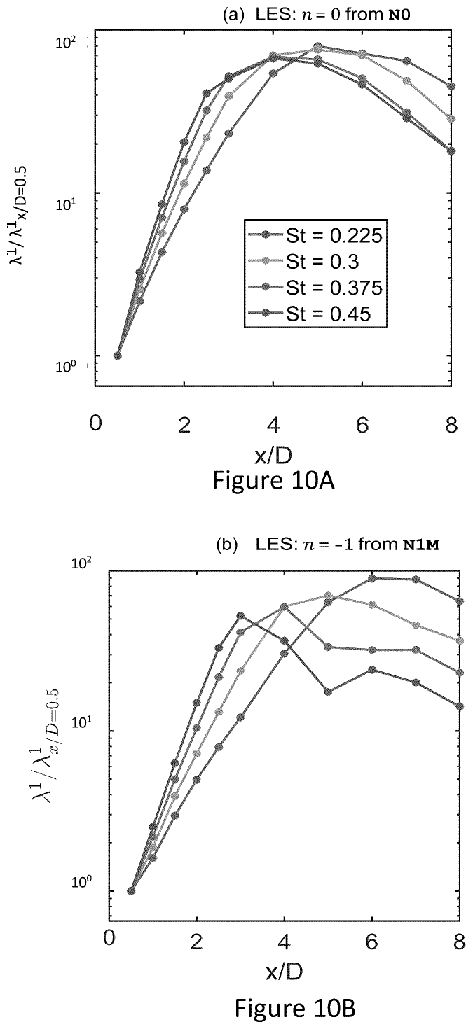

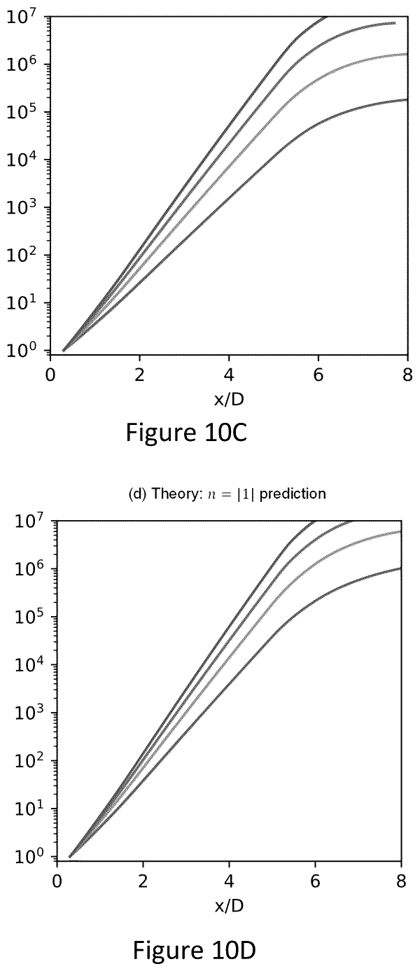

The streamwise development of the modal energy eigenvalue, λ¹, for each frequency and azimuthal mode is shown in FIG. 10a,b. In general, the higher frequency excitation leads to an earlier peak in the modal energy compared to the lower frequency modes. For Strouhal numbers St=0.375 or 0.45, the peak energy occurs near x/D≈4.0, while the lowest Strouhal number, St=0.225, peaks near x/D=6.0. In practice, this result implies that the actuation frequency can impact the downstream location where wake mixing occurs, i.e., for larger turbine spacing, a lower Strouhal number can be chosen to create the same wake-mixing effects.

These findings are consistent with the observations of Gupta and Wan and Li et al., who found that the frequency of the most amplified disturbances decreases as a function of the downstream distance. This phenomena can also be explained in greater depth through the use of a spatial linear stability analysis. Through such an analysis, the growth characteristics of a small initial disturbance can be determined from the temporal forcing frequency and a given mean flow wake profile. While the full details of the mathematical formulation are provided in Appendix B, the primary result is that a dispersion relation can be found that relates the spatial growth rate, −αi, as a function of St. This can be integrated to provide the modal energy gain values G [43], which are similar to λ¹, according to Equation (12),

The plots of the modal energy gain predicted by the linear stability theory are shown in FIG. 10c,d. Similar qualitative trends as for the LES data in FIGS. 10A and 10B are seen in the near-wake region, where higher frequency modes initially grow faster for the axisymmetric and first helical modes compared to those for the lower Strouhal numbers. Due to the limitations of the linear stability theory, the saturation point for individual modes is not captured in FIGS. 10C and 10D, but the sensitivity of each frequency's growth rate on the mean flow properties can be investigated.

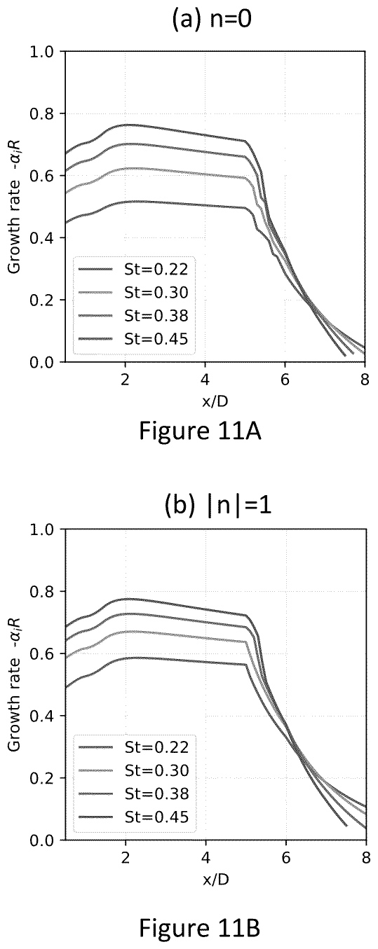

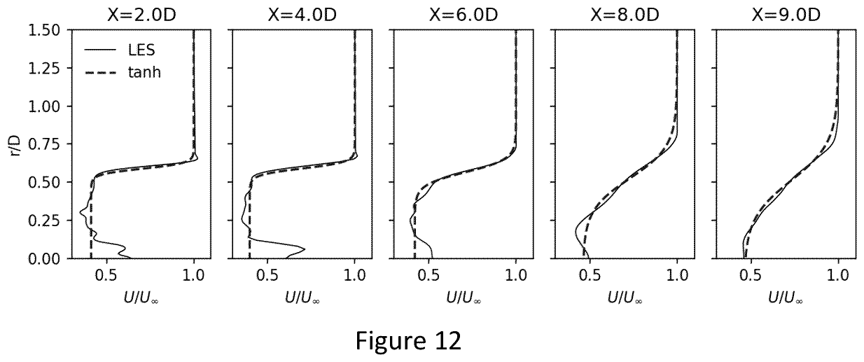

In FIG. 11, the non-dimensional spatial growth rate, −αᵢR, is plotted as a function of the downstream distance, x/D, for St=0.22-0.45 and for the n=0 and n=|1| modes. For x/D<5, −αᵢR remains fairly steady across this frequency range. In this region of the wake, the growth rates between the axisymmetric and first helical modes are also fairly similar, with slightly higher growth of the first helical modes at St=0.22-0.30. However, for x/D>6, all −αᵢR rapidly decrease, with the fastest stabilization occurring for the highest frequency modes. This rapid change in behavior is brought about by the end of the potential core region of the wake profile and rapid thickening of the wake shear layers (FIG. 12). Note that in this downstream region of the wake, the n=|1| modes remain more unstable compared to the n=0 modes, especially at low frequencies.

In summary, the disclosure demonstrates aspects of the growth and meandering of actuated, unstable normal modes in wind turbine wake flows. When intentionally excited, these modes produce an increase in turbulent entrainment and velocity recovery in the wind turbine wake, which can be of practical benefit to wind farms. Interpreting the wake perturbations in light of the mathematical framework developed for related free shear flows (i.e., jets and bluff-body wakes) provides insight on the success of certain methods of wake actuation. Specifically, the modal decomposition of LES data on an idealized wind turbine configuration shows that the counter-clockwise helix forcing strategy (i.e., the N1M case) that has proven successful in the wind turbine controls community had the largest peak modal energy gain of any case, corroborating findings about the most unstable mode in jet and bluff-body flows. Combining the clockwise and counter-clockwise helix forcing (i.e., the N1P1M_CL00 and N1P1M_CL90 cases) in a double-helix approach produced higher recovery than the other strategies, with the up-and-down forcing pattern of the N1P1M_CL00 case performing better than the N1PIM_CL90 case as was also found in an early study of wake-mixing techniques.

An unexpected result of the analysis presented herein is that for the N1P1M_CL00 case, the axisymmetric n=0 mode grows significantly despite only the n=+1 modes being explicitly forced. A further unexpected result is that the n=0 mode was the most unstable in the baseline (i.e., unactuated) wake, followed closely by the n=+1 and −1 modes.

Furthermore, this disclosure shows that wind turbine wakes can be modified to reduce wake deficits and enhance wake mixing by applying specific time periodic and spatially periodic modifications to the rotor forces, such as the rotor thrust. These periodic modifications can be enacted through multiple mechanisms but is most easily achievable through periodic pitching of each turbine blade. The different blade pitch actuation methods can lead to strategies such as dynamic induction control which allows for a side-to-side meandering of the wake.

The blade pitch variations are applied periodically in time and azimuthally in space, with a specified peak-to-peak amplitude A about nominal pitch set point (the normal pitch setting when active wake control is not used). The modulations in time are defined using a non-dimensional frequency St=fD/U which is the frequency f (in Hertz) scaled by the rotor diameter and inflow wind speed. The spatial modulations of the blade pitch are defined in terms of the azimuthal coordinate as each blade rotates about the rotor shaft. The type of azimuthal variations can be characterized through an azimuthal mode number n, which indicates the number of complete azimuthal pitch cycles for every revolution of the rotor. For instance, a mode number n=0 corresponds to no changes in blade pitch due to solely to azimuthal position. In this case, the blade pitching motion is modulated purely as a function of time. A mode number n=1 indicates that the blade will complete 1 pitch cycle for every 360° revolution of the rotor, n=2 corresponds to 2 pitch cycles per rotor revolution, and similarly for higher values of n.

A pitch signal can be composed of multiple pitch modulations added together to induce a specific wake behavior. For instance, a pitch signal which composed of an n=+1 mode and also an n=−1 mode, both modulated at the same temporal St frequency can lead to a side-to-side meandering of the wake. Furthermore, by clocking the initial phase of the modulation appropriately, the same n=+1 and n=−1 mode combination can lead to an up-and-down motion of the wake. The effectiveness of each pitch actuation method at modifying the wake behavior depends on the inflow wind characteristics (wind speed, shear, veer), atmospheric stratification, turbine operating point, and surrounding turbines in the wind farm.

Note that other turbine actuation methods also achieve the same wake modifications as blade pitch variation. For instance, the use of actively deployed flaps or boundary layer control mechanisms which can be modulated in both time and azimuthally in space. These methods can change the individual blade thrust and drag in the same manner as blade pitch, and so lead to the same wake modifications.

In an embodiment, active wake control (AWC) strategy for downstream turbine wake recovery while simultaneously minimizing increases on turbine loads are disclosed. The AWC strategy uses individual pitch control (IPC) or rotor speed control actuation to introduce perturbations into downstream wake flow. The frequency or frequencies, waveform or waveforms, and amplitude or amplitudes of the pitch and/or rotor speed actuation are determined from measurements of the atmospheric inflow and a combination of optimal fluid control and stability theory.

In an embodiment, AWC control uses a periodic aerodynamic thrust variation through rotor speed variation.

In an embodiment, AWC control uses a periodic aerodynamic blade loading variation. In various embodiments, different ways to vary loading may include actuating gurney flaps, plasma actuation, blowing/suction on the blade surface, etc. In an embodiment, IPC and rotor speed control may be used as they are immediately available on modern wind turbines. In other embodiments, other means of creating a periodic aerodynamic loading variation on the blade with a prescribed azimuthal pattern around the rotor may be used.

In an embodiment, two frequencies may be combined to excite multiple unstable modes; in some embodiments this can be done by assigning different frequencies to different control vectors (e.g., pitch and rotor speed).

In an embodiment, AWC may be used on one or more turbines in a wind farm and/or integrated into the overall wind farm operation to improve energy production.

The following elements of an AWC strategy according to an embodiment of the disclosure are described below.

1. AWC with frequency and amplitude actively determined by measurements of the inflow. The necessary control inputs for AWC based on upstream (or “feedforward”) measurements of the atmospheric inflow. The measurements can be provided by upstream meteorological masts, feedforward lidar sampling, radar, or other similar measurement techniques. Measurements of the wind speed, shear, wind direction, temperature profile, turbulence intensity, and atmospheric stratification will be provided to the turbine control system to calculate the necessary flow perturbations. Inflow conditions can also be obtained indirectly for the purpose of AWC by derived methods such as instantaneous strain measurements on the individual blades.

2. Employing individual pitch control (IPC) and/or rotor speed control to excite the optimal perturbations which maximize downstream wake recovery and minimize loading. The measurements inputs from element 1 above are used in combination with the current turbine operating to derive the necessary control signals to actuate the individual pitch blade control mechanism of the wind turbine. Based on the wind speed, atmospheric stratification, and turbine operating point, the optimal frequency and amplitude of the pitch control will be determined from shear flow stability theory. An initial description of the wake stability theory, including the behavior of perturbations in non-axisymmetric wakes with shear and temperature stratification, is provided in the attached document wakestability.pdf. From the theory, the optimal Strouhal number in the given conditions can be determined. The required amplitude of the flow perturbations, and hence the blade pitching motion, can also be determined from the predicted instability amplitude gain from the current wake conditions. For example, when the predicted instability amplitude gain is high, a smaller amplitude of blade pitch can be adopted and still achieve meaningful power improvement in the wind farm.

3. Optimal pitching waveforms for active wake control. The control signal for any active wake control (AWC) implementation must take the form of a wave with a period, amplitude, duty cycle, and waveform (the shape of one period). These parameters can all be optimized for multiple objectives including, but not limited to, increasing and/or accelerating wake mixing and recovery or reducing ultimate and/or fatigue loads on the actuated and/or downstream turbines. The duty cycle could also be optimized for multiple objectives. For example, it may be that the optimal control signal for accelerated wake recovery only requires a certain change in thrust over the optimal period as opposed to a certain magnitude of thrust. In this case, the duty cycle might be optimized to reduce the amount of time spent at higher thrust in one period and thereby decrease the loads on the actuated turbine.

4. Optimization of amplitudes (of control signal) for active wake control. The amplitude, or range over which the control signal varies, can be also optimized. The amplitude will relate directly to magnitude of perturbation that AWC adds to the flow around the turbine but will also relate directly to the magnitude of loads and changes in loads, or fatigue, on the turbine using AWC. It may be, for example, that, during some atmospheric conditions, a smaller amplitude will suffice to meet optimization objectives, for example, balancing an accelerated wake recovery with a minimal increase in turbine loads. With other optimization objectives, it may be preferred to use a larger amplitude.

5. Optimization of mean thrust, pitch or other control quantity value for active wake control. A waveform based on the thrust of the actuated turbine could have a mean value equal to the standard operating point of the turbine when not using AWC, a mean value that is higher (over-inductive), or a mean value that is lower (under-inductive), and these options could affect the recovery of that turbine's wake and the loads on that turbine. These optimizations can further be cast in terms of the pitch (for collective pitch control) or pitches (for individual pitch control) of the turbine's blades. It could also use the torque control, rotation rate, or other quantity that can be controlled either directly or indirectly on the turbine.

6. Closed loop controller for active wake control. In addition to the upstream measurements described in element 1 above, downstream measurements of the wake behavior could be used in a closed loop control strategy with AWC. The downstream measurements of wake wind speed or turbulence will be sent back to the turbine control to adjust the pitch control actuation.

7. Combination of wake steering control with individual pitch control. Depending on the wind flow conditions and turbine operating point, the AWC strategy with individual pitch control can be combined with turbine wake steering to both deflect the wake and increase the downstream wake recovery. This may be necessary under certain atmospheric conditions or wind farm configurations, such as very closely spaced turbines, where the flow perturbations have insufficient distance to sufficiently grow before impacting downstream rows.

The control to modify operations based on reducing wake impact on operations is integrated into the wind farm operator's control system. In other embodiments, the modification of operations would be fully embedded in the farm's internal control architecture.

In such a manner, the AWC accelerates wake recovery produced by the wind turbine, passing more energetic air to the downstream wind turbines. The downstream turbine, now receiving more energetic air, now produces a stronger and deeper wake. Thus, AWC on the second turbine is implemented to produce more energetic air for the third turbine. This cascade effect continues throughout the wind farm from the upstream to the downstream turbines. It is desirable to implement AWC in such way that it minimizes increases on turbine loads, relative to the gain of energy recovered. This is true if AWC is only implemented on the first row of turbines, first and second row or any combination of rows throughout the wind farm. Since one turbine performance and structural loading affect each other, one cannot decide the AWC isolated, but must consider the whole system.

The cascading of wakes is sometimes called deep array effects, but many other names for this are used throughout the wind industry. It is important to recognize AWC is not limited to only manipulating the upstream turbines but also inside the array. It is also important to recognize that manipulation with AWC is different for the individual turbine in the array within the wind farm. In the extreme, where two wind farms shadow each other, often described as wind farm shadows, AWC can be implemented to mitigate energy losses in the downstream wind farm by AWC in the first wind farm, AWC in the second wind farm or a combination of the two. The methodology presented in this invention is not limited to manipulating individual turbines, the AWC manipulation can manipulate entire wind farms for the benefits of both the wind farm itself as well as the downstream wind farm or wind farms.

According to this disclosure, an AWC strategy implements control and determination of the individual blade pitch settings by combining measurements of the inflow wind conditions with flow control and stability theory to yield the optimal pitch actuation frequency and amplitude. These periodic changes in blade pitch will excite unstable flow perturbations in the downstream wake that reduce the downstream wake deficit and increase the available wind resource for downstream turbines. Implementations of this active wake control strategy will possibly use optimal pitching waveforms, employ a closed loop controller and sensor(s), and combine individual pitch control with turbine wake steering.

While blade pitching is relatively fast compared to existing state of the art wake steering type wake control, controlling rotor speed is much faster. The desired effect of the blade pitching can also be obtained by changing the rotor speed. One benefit of using rotor speed control over blade pitch control is that changes in rotor speed do not incur any mechanical damage to the pitch bearings or any other component. An optimal control strategy AWC can be implemented by rotor speed control, pitch control or a combination of the two. Together, or separate, the AWC is ultimately designed by a number of input wave forms overlaying the ordinary wind turbine control system to achieve the AWC.

The input wave forms to the AWC can be derived from a number of methods. These wave forms are designed to stimulate the desired effect on the wind turbine wake under the given wind inflow conditions to the individual wind turbine while taking into account the desired effect for the entire wind farm and/or the wind farm and/or adjacent wind farms. It is understood that wave forms are composed of a number of frequencies and amplitudes that are super imposed.

Inflow conditions to an individual wind turbine within the upstream front of a windfarm, within a wind farm, or in an adjacent wind farm can be determined in many ways as a relevant input to AWC. For example, wind shear may be extremely difficult to measure directly with wind measurement equipment but is easily quantified by measuring individual blade root strain measurements. A simple transformation provides more than enough information to perform a highly effective AWC with individual blade pitch control (IPC) and/or rotational speed changes. Similarly, a frequency decomposition of the instantaneous torque upon the drive train combined with the actual rotor azimuth position can reveal the instantaneous inflow condition, thus providing an input to the AWC that is much faster than any instrumentation that can measure inflow directly. Thus, information needed as inputs to effectively implement AWC can already be obtained from post-processing signals from existing sensors on wind turbines.

The present disclosure is directed to determining the optimal blade pitch control method for AWC based on one or more upstream wind measurements or determined wind speed parameters of the wind upstream of the turbine. Parameters to be adjusted include the frequency, amplitude, and shape of the waveform.

The present disclosure is further directed to active wake control method that includes:
1. AWC with frequency and amplitude actively determined by measurements of the inflow to the wind farm and the individual wind turbine within the wind farm and/or the individual wind turbine in one or multiple upstream wind farms;
1. Measurement of the inflow is understood to be an artifact that describes a characteristic parameter which allows to determine a relevant inflow parameter that can determine the instantaneous wind speed and wind shear for the individual wind turbine;
2. Employing individual pitch control (IPC) and/or rotor speed control to excite the optimal perturbations which maximize downstream wake recovery and minimize loading;
3. Optimal pitching and/or rotor speed waveforms for active wake control;
4. Optimization of amplitudes (of control signal) for active wake control;
5. Optimization of mean thrust, pitch or other control quantity value for active wake control;
6. Closed loop controller for active wake control; and
7. Combination of wake steering control with individual pitch control and rotor speed control;
8. All of the above where the inflow is considered to be a combination of inflow
from an upstream wind farm to a downstream wind farm.

The present disclosure is further directed to implement a closed-loop controller to implement the above optimal blade pitch control method. The controller may be a processor that may include software and/or firmware that includes instructions for executing the method, the instructions embedded on non-transitory medium. In other embodiments, the processor may be external to the controller.

The present disclosure is further directed to AWC with frequency and amplitude actively determined by measurements of the inflow to the wind farm and the individual wind turbine within the wind farm and/or the individual wind turbine in one or multiple upstream wind farm implemented in a control system that includes a processor that includes a non-transitory storage medium, the processor executing instructions stored in the storage medium the executes the following steps:
1. Measurement of the inflow is understood to be an artifact that describes a characteristic parameter which allows to determine a relevant inflow parameter that can determine the instantaneous wind speed and wind shear for the individual wind turbine;
2. Employing individual pitch control (IPC) and/or rotor speed control to excite the optimal perturbations which maximize downstream wake recovery and minimize loading;
3. Optimal pitching and/or rotor speed waveforms for active wake control;
4. Optimization of amplitudes (of control signal) for active wake control;
5. Optimization of mean thrust, pitch or other control quantity value for active wake control;
6. Closed loop controller for active wake control; and
7. Combination of wake steering control with individual pitch control and rotor speed control;
8. All of the above where the inflow is considered to be a combination of inflow from and upstream wind farm to a downstream wind farm.

The invention being thus described, it will be obvious that the same may be varied in many ways. Such variations are not to be regarded as a departure from the spirit and scope of the invention, and all such modifications as would be obvious to one skilled in the art are intended to be included within the scope of the appended claims. It is intended that the scope of the invention be defined by the claims appended hereto. The entire disclosures of all references, applications, patents and publications cited above are hereby incorporated by reference.

In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. An active wake control method, comprising:
periodically changing blade pitch of one or more blades of a first wind turbine to accelerate wake recovery.

2. The method of claim 1, wherein the first wind turbine is a member of a wind farm comprising two or more wind turbines of which a second wind turbine is downstream the first wind turbine.

3. The method of claim 1, further comprising:
measuring a wind measurement upstream of the first wind turbine or using a measure representing an upstream wind measurement from the first wind turbine; and
determining a blade pitch control of the first wind turbine operation to minimize, reduce or eliminate downstream wake produced by the first wind turbine; and determining an optimal pitch schedule.

4. The method of claim 3, wherein the blade pitch control adjusts at least one parameter selected from the group consisting of frequency, amplitude, and shape of the waveform, the waveform being the time series of the periodic variation in blade pitch.

5. The method of claim 1, wherein the periodically changing blade pitch is determined by the following steps:
a. determining frequency and amplitude of blade pitch periodic changes by measurements of inflow or emulations of inflow at the first wind turbine;
b. employing individual pitch control (IPC) to the one or more blades to excite perturbations in wind flow to improve downstream wake recovery while minimizing blade loading.

6. The method of claim 1, further comprising:
using pulse, rotor speed and/or helix forcing controls.

7. A controller, comprising;
a module that includes a processor comprising non-transitory storage medium for providing instructions to a turbine blade pitch actuator, the instructions comprising:
periodically changing blade pitch of one or more blades of a first wind turbine to accelerate wake recovery.

8. The controller of claim 7, wherein the first wind turbine is a member of a wind farm comprising two or more wind turbines of which a second wind turbine is downstream the first wind turbine.

9. The controller of claim 7, further comprising:
measuring a wind measurement upstream of the first wind turbine or using a measure representing an upstream wind measurement from the first wind turbine; and
determining a blade pitch control of the first wind turbine operation to minimize, reduce or eliminate downstream wake produced by the first wind turbine; and determining an optimal pitch schedule.

10. The controller of claim 9, wherein the blade pitch control adjusts at least one parameter selected from the group consisting of frequency, amplitude, and shape of the waveform, the waveform being the time series of the periodic variation in blade pitch.

11. The controller of claim 7, wherein the periodically changing blade pitch is determined by the following steps:
a. determining frequency and amplitude of blade pitch periodic changes by measurements of inflow or emulations of inflow at the first wind turbine;
b. employing individual pitch control (IPC) to the one or more blades to excite perturbations in wind flow to improve downstream wake recovery while minimizing blade loading.

12. The controller of claim 7, further comprising:
using pulse, rotor speed and/or helix forcing controls in combination with periodically changing blade pitch.
